(19) United States
(12) Patent Application Publication
(10) Pub. No.: US 2019/0018620 A1
(43) Pub. Date: Jan. 17, 2019

(54) IMAGE FORMING APPARATUS AND CONTROL METHOD

(71) Applicant: TOSHIBA TEC KABUSHIKI KAISHA, Tokyo (JP)

(72) Inventor: Shinji ONO, Mishima Shizuoka (JP)

(21) Appl. No.: 16/031,129

(22) Filed: Jul. 10, 2018

(30) Foreign Application Priority Data
Jul. 12, 2017 (JP) 2017-136329

(51) Int. Cl. G06F 3/12; H04L 7/033

(52) U.S. Cl. CPC G06F 3/122; G06F 3/1239; H04L 7/0331

(57) ABSTRACT

In accordance with an embodiment, an image forming apparatus includes a first processor configured to generate a first operation signal and a second processor configured to generate a second operation signal indicating an operation state of the second processor. A pin input is configured to generate a second output signal, and an application-specific integrated circuit (ASIC) configured to generate data and output the data based on the first output signal or the second output signal.

### CROSS-REFERENCE TO RELATED APPLICATION

This application is based upon and claims the benefit of priority from Japanese Patent Application No. 2017-136329, filed Jul. 12, 2017, the entire contents of which are incorporated herein by reference.

### FIELD

Embodiments described herein relate generally to an image forming apparatus and a control method.

### BACKGROUND

In a conventional ASIC, a dedicated output pin is provided according to an output mode. However, as miniaturization of chips progress, it becomes difficult to provide the output pin according to the output mode. Therefore, in a case of an ASIC accessed by a plurality of CPUs, a plurality of data is output by switching the output to each CPU by a main CPU. Therefore, even if the ASIC outputs data relating to the CPUs other than the main CPU, the main CPU switches the output and outputs the data. In such a method, even if it is desired to output the data relating to CPUs other than the main CPU, as in the case of evaluating the ASIC, there is a case in which the data cannot be output unless the main CPU controls the output.

### DESCRIPTION OF THE DRAWINGS

FIG. 1 is an external view exemplifying the overall constitution of an image forming apparatus according to an embodiment;

FIG. 2 is a functional block diagram illustrating the functional components of the image forming apparatus according to the embodiment;

FIG. 3 is a diagram exemplifying the constitution of an ASIC according to the embodiment;

FIG. 4 is a diagram illustrating a control image of a normal state of the ASIC according to the embodiment;

FIG. 5 is a diagram illustrating a control image at the time of evaluating the ASIC according to the embodiment;

FIG. 6 is a table illustrating a control state of the ASIC by a pin input section according to the embodiment; and

FIG. 7 is a flowchart illustrating a specific example of the flow of a processing at the time of evaluating the ASIC according to the embodiment.

### DETAILED DESCRIPTION

In accordance with an embodiment, an image forming apparatus comprises a first processor configured to generate a first operation signal indicating an operation state of the first processor, and configured to generate a first output signal which outputs data generated by the operation of the first processor. The image forming apparatus further comprises a second processor configured to generate a second operation signal indicating an operation state of the second processor, and a pin input configured to generate a second output signal for outputting data generated by the second processor if the first operation signal and the second operation signal satisfy predetermined conditions. The image forming apparatus also comprises an application-specific integrated circuit (ASIC) configured to generate data and output the data based on the first output signal or the second output signal.

Hereinafter, an image forming apparatus and a control method according to an embodiment are described with reference to the accompanying drawings.

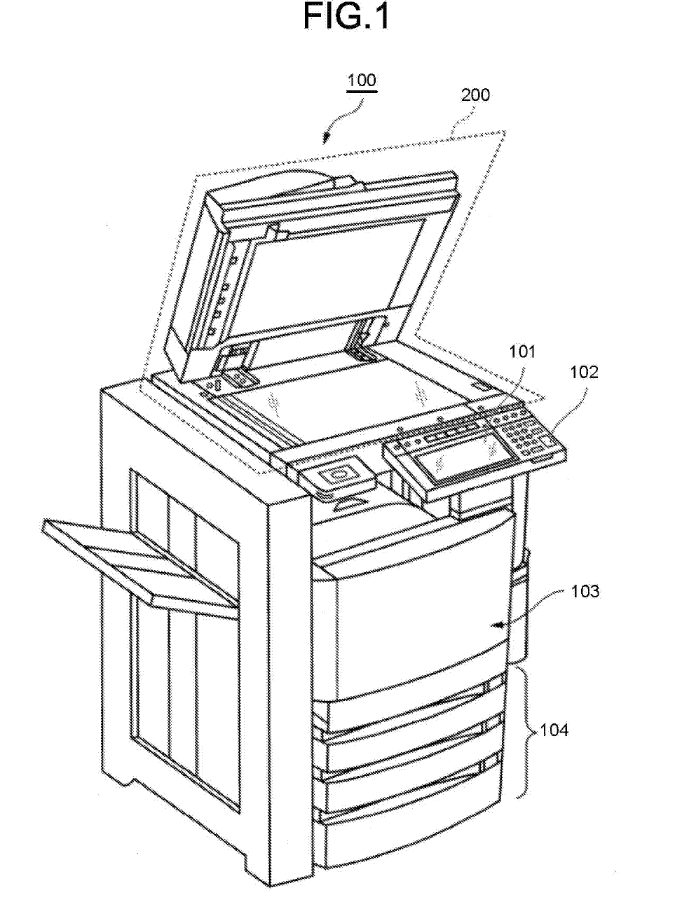

FIG. 1 is an external view exemplifying the overall constitution of an image forming apparatus 100 according to the embodiment. The image forming apparatus 100 is, for example, a multi-functional peripheral. The image forming apparatus 100 includes a display 101, a control panel 102, a printer section 103, a sheet housing section 104 and an image reading section 200. Furthermore, the printer section 103 of the image forming apparatus 100 is a device for fixing a toner image.

The image forming apparatus 100 forms an image on a sheet using a developer such as a toner. The sheet is, for example, a paper or a label paper. The sheet may optionally be another object as long as the image forming apparatus 100 can form an image on a surface thereof.

The display 101 is an image display device such as a liquid crystal display, an organic EL (Electro Luminescence) display and the like. The display 101 displays various information on the image forming apparatus 100.

The control panel 102 includes a plurality of buttons. The control panel 102 receives an operation by a user. The control panel 102 outputs a signal in response to an operation executed by the user to a controller of the image forming apparatus 100. Furthermore, the display 101 and the control panel 102 may constitute an integrated touch panel.

The printer section 103 forms an image on the sheet based on image information generated by the image reading section 200 or image information received through a communication path. The printer section 103 forms an image through the following process, for example. An image forming section of the printer section 103 forms an electrostatic latent image on a photoconductive drum based on the image information. The image forming section of the printer section 103 forms a visible image by attaching the developer to the electrostatic latent image. Toner is exemplified as a concrete example of the developer. A transfer section of the printer section 103 transfers the visible image onto the sheet. A fixing section of the printer section 103 fixes the visible image on the sheet by heating and pressurizing the sheet. The sheet on which the image is formed may be a sheet housed in the sheet housing section 104, or a sheet that is manually fed.

The sheet housing section 104 houses the sheet used in the image formation by the printer section 103.

The image reading section 200 reads the image information which is a reading object as intensity of light. The image reading section 200 records the read image information. The recorded image information may be transmitted to another information processing apparatus via a network. The recorded image information may be used to form an image on the sheet by the printer section 103.

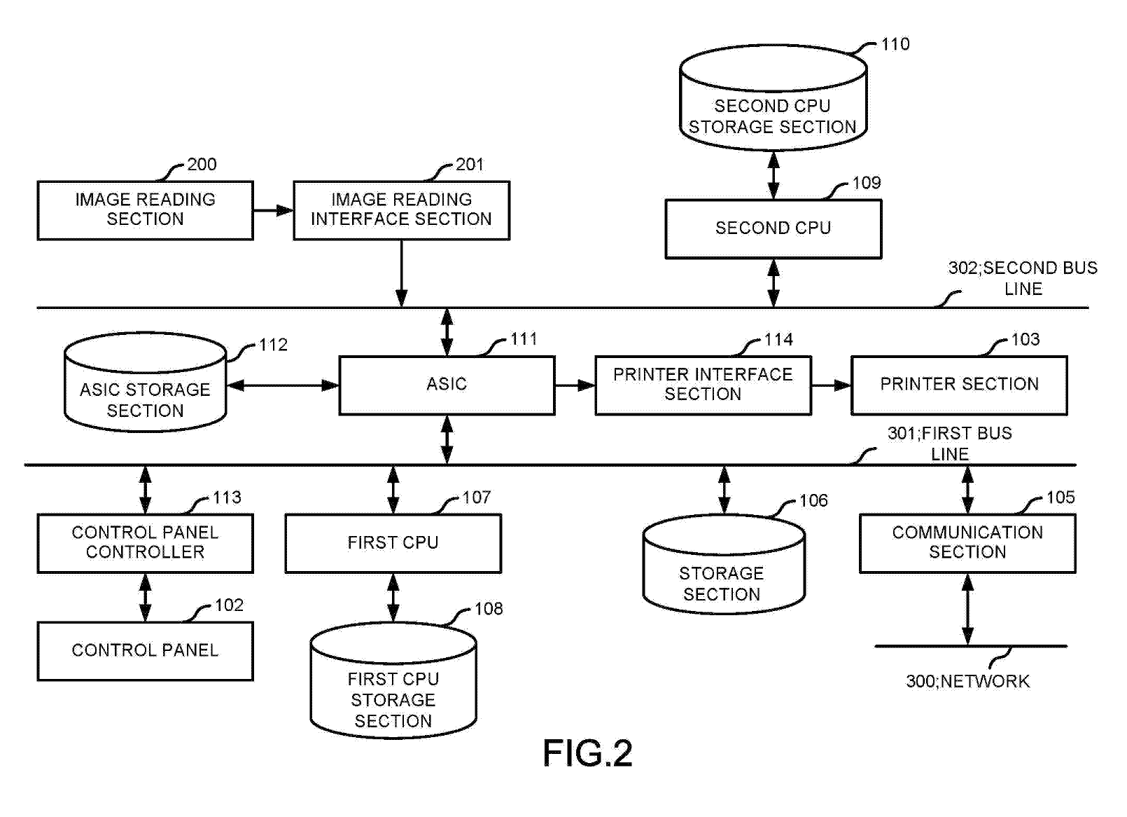

FIG. 2 is a functional block diagram illustrating the functional components of the image forming apparatus 100 according to the embodiment. The image forming apparatus 100 includes the control panel 102, the printer section 103, a communication section 105, a storage section 106, a first CPU (Central Processing Unit) 107, a first CPU storage section 108, a second CPU 109, a second CPU storage section 110, an ASIC (Application Specific Integrated Circuit) 111, an ASIC storage section 112, a control panel controller 113, a printer interface section 114, the image reading section 200, an image reading interface section 201, a first bus line 301 and a second bus line 302. Hereinafter, the description of the functions described in FIG. 1 is omitted.

The communication section 105 is a network interface. The communication section 105 communicates with an external terminal via a network 300. The external terminal is, for example, an information processing apparatus such as a personal computer, a smartphone, a tablet computer, a server, an industrial computer, or the like. The communication section 105 may perform communication by a communication method such as a wireless LAN (Local Area Network), a wired LAN, a Bluetooth® Technology, a LTE (Long Term Evolution) (registered trademark) or the like.

The storage section 106 is constituted by using a storage device such as a magnetic hard disk device, a semiconductor storage device, a ROM (Read Only Memory), or a RAM (Random Access Memory). The storage section 106 stores the data processed by the ASIC 111. The storage section 106 stores programs executed by the image forming apparatus 100, processing data, and the like.

The first CPU 107 accesses the ASIC 111 and controls the ASIC 111. The first CPU 107 controls the ASIC 111 to operate a first data processing section 121 and a third data processing section 123 of the ASIC 111. In the present embodiment, the first CPU 107 is described as a main CPU of the image forming apparatus 100. The main CPU generates instruction information for determining data output from the ASIC 111. The main CPU outputs the instruction information to the ASIC 111. The main CPU switches the output data by changing setting of a register 132 of the ASIC 111. The first CPU 107 is an aspect of a first processing section.

The first CPU storage section 108 is a storage device such as a magnetic hard disk device, a semiconductor storage device, a ROM or a RAM. The first CPU storage section 108 stores data processed by the first CPU 107. The first CPU storage section 108 stores programs executed by the first CPU 107, processing data, and the like.

The second CPU 109 accesses the ASIC 111 and controls the ASIC 111. The second CPU 109 controls the ASIC 111 to operate a second data processing section 122 of the ASIC 111. In the present embodiment, the second CPU 109 is described as a sub-CPU of the image forming apparatus 100. The sub-CPU differs from the main CPU in that the sub-CPU does not generate the instruction information for determining data output from the ASIC 111. The second CPU 109 is an aspect of a second processing section.

The second CPU storage section 110 is a storage device such as a magnetic hard disk device, a semiconductor storage device, a ROM or a RAM. The second CPU storage section 110 stores data processed by the second CPU 109. The second CPU storage section 110 stores programs executed by the second CPU 109, processing data, and the like.

The ASIC 111 generates data under the control of the first CPU 107 and the second CPU 109. The ASIC 111 may store the generated data in the storage section 106, or the ASIC 111 may output the generated data to the printer interface section 114. The ASIC 111 switches the output data in response to the input from a pin input section 115. The ASIC 111 may switch output data in response to an instruction from the first CPU 107. The ASIC 111 is an aspect of a controller.

The ASIC storage section 112 is a storage device such as a magnetic hard disk device, a semiconductor storage device, a ROM or a RAM. The ASIC storage section 112 stores data processed by the ASIC 111. The ASIC storage section 112 stores programs executed by the ASIC 111, processing data, and the like.

The control panel controller 113 controls the operation of the control panel 102. The control panel controller 113 displays an image on the control panel 102 according to the processing of the first CPU 107 and the ASIC 111.

The printer interface section 114 controls the operation of the printer section 103. The printer interface section 114 enables the printer section 103 to form an image in accordance with the processing of the ASIC 111.

The image reading interface section 201 controls the operation of the image reading section 200. The image reading interface section 201 inputs the image information read by the image reading section 200 to the ASIC 111 according to the processing of the second CPU 109 and the ASIC 111.

The first bus line 301 connects the communication section 105, the storage section 106, the first CPU 107, the ASIC 111 and the control panel controller 113 to be communicable with each other. The second bus line 302 connects the second CPU 109, the ASIC 111, and the image reading interface section 201 to be communicable with each other.

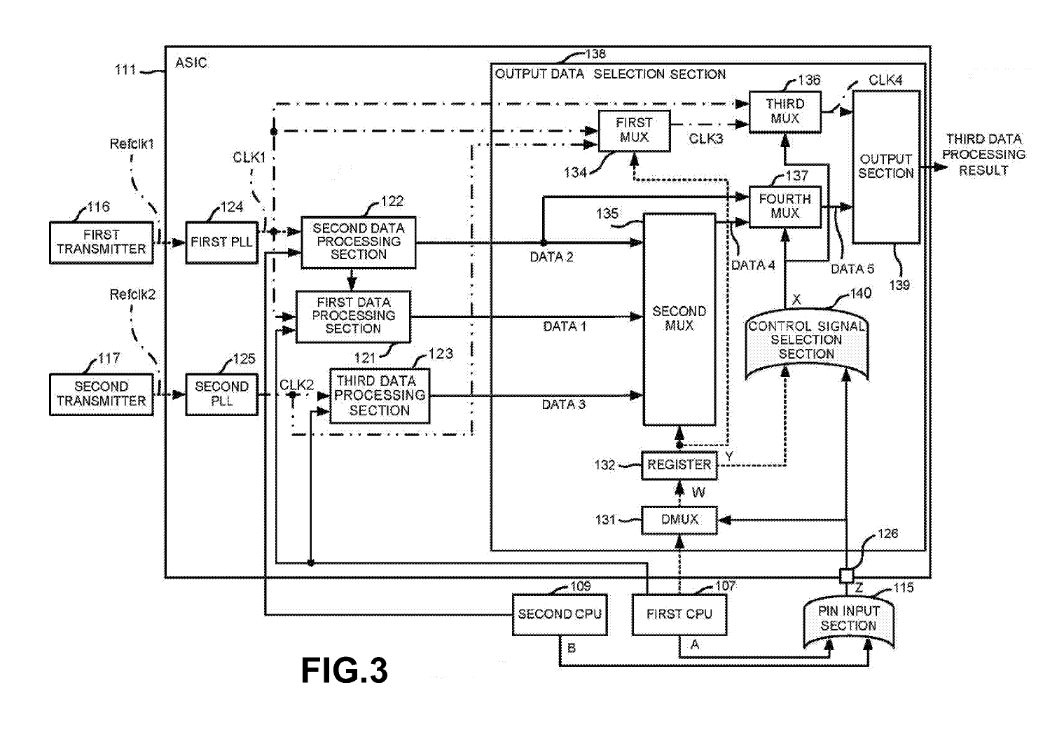

FIG. 3 is a diagram exemplifying the constitution of the ASIC 111 according to the embodiment. The ASIC 111 includes the first data processing section 121, the second data processing section 122, the third data processing section 123, a first PLL 124, a second PLL 125 and an external pin 126. An output data selection section 138 includes a DMUX 131, the register 132, a first MUX 134, a second MUX 135, a third MUX 136, a fourth MUX 137, a control signal selection section 140 and an output section 139. A solid line in FIG. 3 shows the flow of data. A dashed line in FIG. 3 indicates the flow of a clock. The dotted line in FIG. 3 shows the flow of access to the register and output from the register.

The first CPU 107 controls the first data processing section 121 and the third data processing section 123. The second CPU 109 controls the second data processing section 122. The first data processing section 121 operates according to a CLK 1 output from the first PLL 124. The first data processing section 121 outputs data 1 to the second MUX 135. The first PLL 124 operates according to a Refclk 1 output from a first transmitter 116.

The second data processing section 122 operates according to the CLK 1 output from the first PLL 124. The second data processing section 122 outputs data 2 to the second MUX 135 and the fourth MUX 137. The third data processing section 123 operates according to a CLK 2 output from the second PLL 125. The second PLL 125 operates according to a Refclk 2 output from a second transmitter 117.

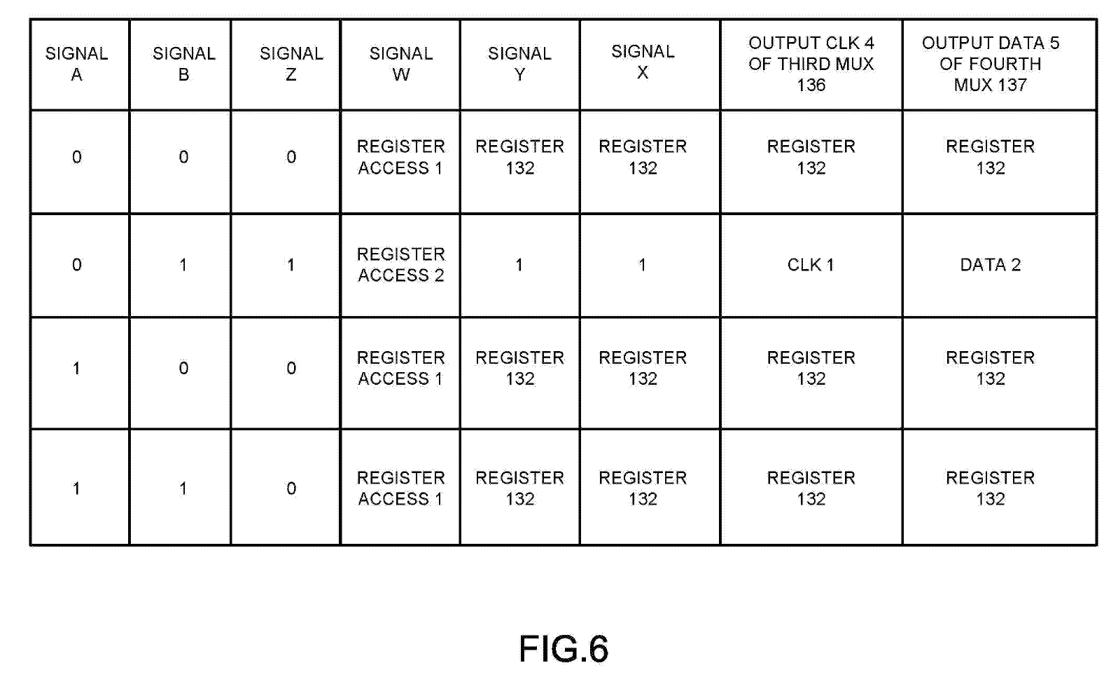

The pin input section 115 outputs a signal Z to the external pin 126 based on an operation state of the first CPU 107 and an operation state of the second CPU 109. More specifically, the first CPU 107 outputs 1 as a signal A if it is in a control execution state. The second CPU 109 outputs 1 as a signal B if it is in the control execution state. The pin input section 115 outputs the signal Z to the DMUX 131 and the control signal selection section 140 via the external pin 126 based on the output from the signals A and B. The output by the pin input section 115 is described in detail in FIG. 6. The signal A is an aspect of first operation information indicating the operation state of the first CPU 107. The signal B is an aspect of second operation information indicating the operation state of the second CPU 109. The pin input section 115 is an aspect of output information generation section. The signal Z is an aspect of second output information.

The DMUX 131 is a processing section having a function of distributing an input signal to a plurality of output. The DMUX 131 outputs a signal W for performing a predetermined setting to the register 132. Specifically, if a signal is received from the first CPU 107, the DMUX 131 outputs the signal W so that data (e.g., data generated according to the instruction from the first CPU 107) is output in response to the signal received from the first CPU 107. If the signal Z is received from the pin input section 115, the DMUX 131 outputs the signal W so that data on the second CPU 109 is output. The DMUX 131 is, for example, a demultiplexer. The signal received from the first CPU 107 by the DMUX 131 is an aspect of first output information.

In response to the signal W received from the DMUX 131, the register 132 outputs a signal relating to output contents of the first MUX 134 and the second MUX 135. Specifically, the register 132 is set in such a manner that the CLK 1 or the CLK 2 is output as CLK 3 which is an output of the first MUX 134. The register 132 is set in such a manner that the data 1 or the data 2 is output as data 4 which, is an output of the second MUX 135. The register 132 outputs a signal Y to the control signal selection section 140 in response to the signal W received from the DMUX 131. The third data processing section 123 outputs the data 3 to the second MUX 135 according to the received CLK 2.

The first MUX 134 has a function of determining an output signal among the plurality of input signals. The second MUX 135, the third MUX 136, and the fourth MUX 137 also have equivalent functions. The first MUX 134, the second MUX 135, the third MUX 136, and the fourth MUX 137 are, for example, multiplexers. The first MUX 134 outputs either signal of the received CLK 1 and CLK 2 as the CLK 3 to the third MUX 136. The first MUX 134 determines which signal of the CLK 1 and the CLK 2 is output in response to the signal received from the register 132.

The second MUX 135 outputs any one of the received data 1, data 2 and data 3 as the data 4 to the fourth MUX 137. The second MUX 135 determines which signal of the data 1, the data 2, and the data 3 is output in response to the signal received from the register 132.

The third MUX 136 outputs either signal of the received CLK 1 and CLK 3 as a CLK 4 to the output section 139. In response to a signal X received from the control signal selection section 140, the third MUX 136 determines which signal of the CLK 1 and the CLK 3 is output.

The fourth MUX 137 outputs either signal of the received data 2 and data 4 as data 5 to the output section 139. The fourth MUX 137 determines which signal of the data 2 and the data 4 is output in response to the signal X received from the control signal selection section 140.

The control signal selection section 140 outputs the signal X in response to the signal Y and the signal Z. Specifically, the control signal selection section 140 outputs the signal X in such a manner that the CLK 1 or the CLK 3 is output from the CLK 4 which is an output of the third MUX 136. The control signal selection section 140 outputs the signal X in such a manner that the data 2 or the data 4 is output from the data 5 which is an output of the fourth MUX 137. The control signal selection section 140 is, for example, a logical operation circuit such as an OR circuit. The output data selection section 138 may be constituted at the outside of the output data selection section 138.

The output section 139 outputs the data 5 as the third data processing result based on the received CLK 4. The third data processing result may be, for example, a print command to the printer section 103.

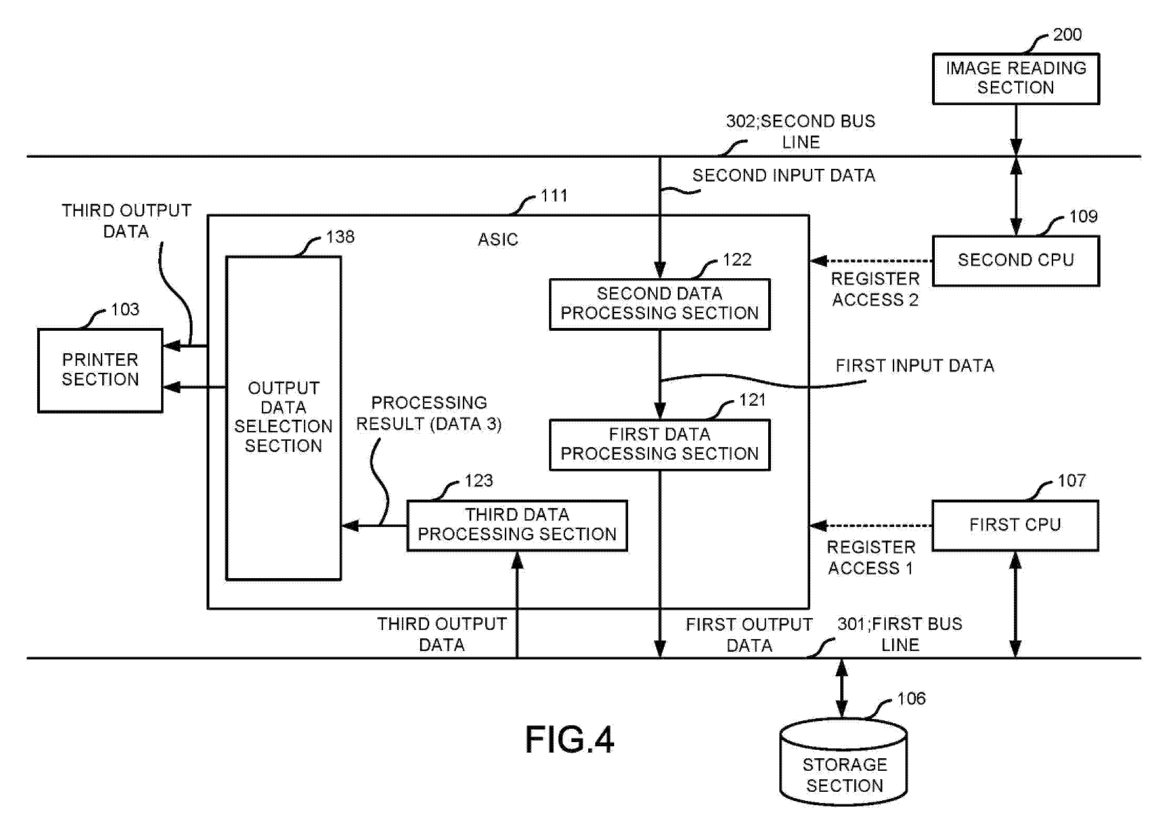

FIG. 4 is a diagram illustrating a control image at a normal state of the ASIC 111 according to the embodiment. In the normal state, the first CPU 107 performs a register access 1 to control the ASIC 111. Regardless of the operation state of the first CPU 107, the second CPU 109 performs a register access 2 to control the ASIC 111. The second data processing section 122 receives the second input data from the second CPU 109. The second input data is, for example, image information generated by the image reading section 200. The second data processing section 122 processes the second input data. The second data processing section 122 outputs the processing result to the first data processing section 121 as first input data.

The first data processing section 121 processes the first input data received from the second data processing section 122. The first data processing section 121 outputs the processing result to the first CPU 107 as the first output data. The first CPU 107 stores the first output data in the storage section 106. The first CPU 107 outputs the first output data as third input data to the third data processing section 123. The ASIC 111 may store the first output data in the storage section 106.

The third data processing section 123 processes the third input data. The third data processing section 123 outputs third output data which is the processing result of the third input data to the output data selection section 138. The output data selection section 138 outputs the processing result by the third data processing section 123 to the printer section 103 as the third output data.

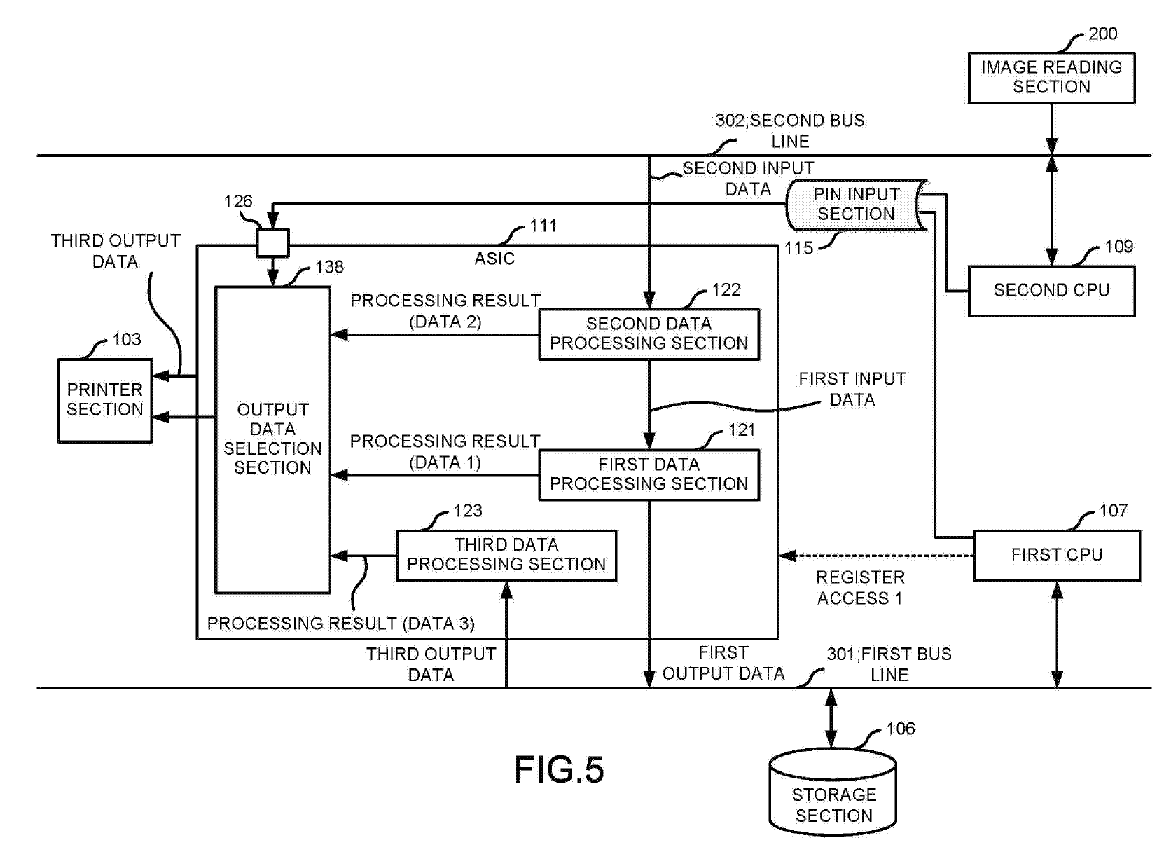

Next, a control image at the time of evaluating the ASIC 111 is described. FIG. 5 is a diagram illustrating a control image at the time of evaluating the ASIC 111 according to the embodiment. At the time of evaluating the ASIC 111, the processing results of the first data processing section 121 and the second data processing section 122 are output to the printer section 103 in some cases.

A case in which the processing result by the first data processing section 121 is output is described. As described in FIG. 3, the first data processing section 121 operates according to the CLK 1 output from the first PLL 124. The third data processing section 123 operates according to the CLK 2 output from the second PLL 125. The output section 139 in the normal state operates according to the CLK 2. Therefore, the first data processing section 121 and the output section 139 are in an asynchronous relationship. If the data 1 which is the processing result of the first data processing section 121 is output from the output section 139, it is necessary to switch the operation clock of the output section 139 to the CLK 1.

The first CPU 107 sets the register 132 such that the CLK 1 is output from the first MUX 134 as CLK3. The first CPU 107 performs setting such that the data 1 is output as the data 4 output by the second MUX 135. With such a constitution, the output section 139 can output the processing result of the first data processing section 121.

A case in which the processing result by the second data processing section 122 is output is described. The second data processing section 122 operates according to the CLK 1 output from the first PLL 124. Therefore, if the data 2 which is the processing result of the second data processing section 122 is output from the output section 139, it is necessary to switch the operation clock of the output section 139 to the CLK 1. Specifically, the pin input section 115 outputs the signal Z such that the CLK 1 is output from the third MUX 136. The pin input section 115 outputs the signal Z such that the data 2 is output from the fourth MUX 137. Therefore, the second CPU 109 can output the data of the second data processing section 122 from the output section 139 without setting the register 132. With such a constitution, the ASIC 111 can output the data of the second data processing section 122 without receiving the control of the first CPU 107 which is the main CPU.

FIG. 6 is a table illustrating the control state of the ASIC 111 by the pin input section 115 according to the embodiment. The table has values of the signal A, the signal B, the signal Z, the signal W, the signal Y, the signal X, the output CLK 4 of the third MUX 136 and the output data 5 of the fourth MUX 137. A case in which the signal A is 0 indicates that the first CPU 107 is in a non-operation state. A case in which the signal A is 1 indicates that the first CPU 107 is in the control execution state. A case in which the signal B is 0 indicates that the second CPU 109 is in the non-operation state. A case in which the signal B is 1 indicates that the second CPU 109 is in the control execution state.

If both signals A and B are 0, the signal Z is 0. If the signal Z is 0, the signal W corresponding to the register access 1 by the first CPU 107 is output from the DMUX 131. The signal Y and the signal X corresponding to the setting of the register 132 by the signal W are output from the register 132. Therefore, contents corresponding to the setting of the register 132 are also output from the CLK 4 which is the output of the third MUX 136 and the data 5 which is the output of the fourth MUX 137. The same is applied to a case in which the signal A is 1 and the signal B is 0, and a case in which the signal A is 1 and the signal B is 1.

If the signal A is 0 and the signal B is 1, the signal Z is 1. If the signal Z is 1, the DMUX 131 outputs the signal W corresponding to the register access 2 by the pin input section 115. 1 is output as the signal Y and the signal X from the register 132. Therefore, the CLK 1 is output from the CLK 4 which is the output of the third MUX 136. From the data 5 which is the output of the fourth MUX 137, the data 2 is output. In the ASIC 111 constituted in this manner, even if the first CPU 107 is in the non-operation state and only the second CPU 109 is operating, regardless of the value of the register 132, the data of the second data processing section 122 is output.

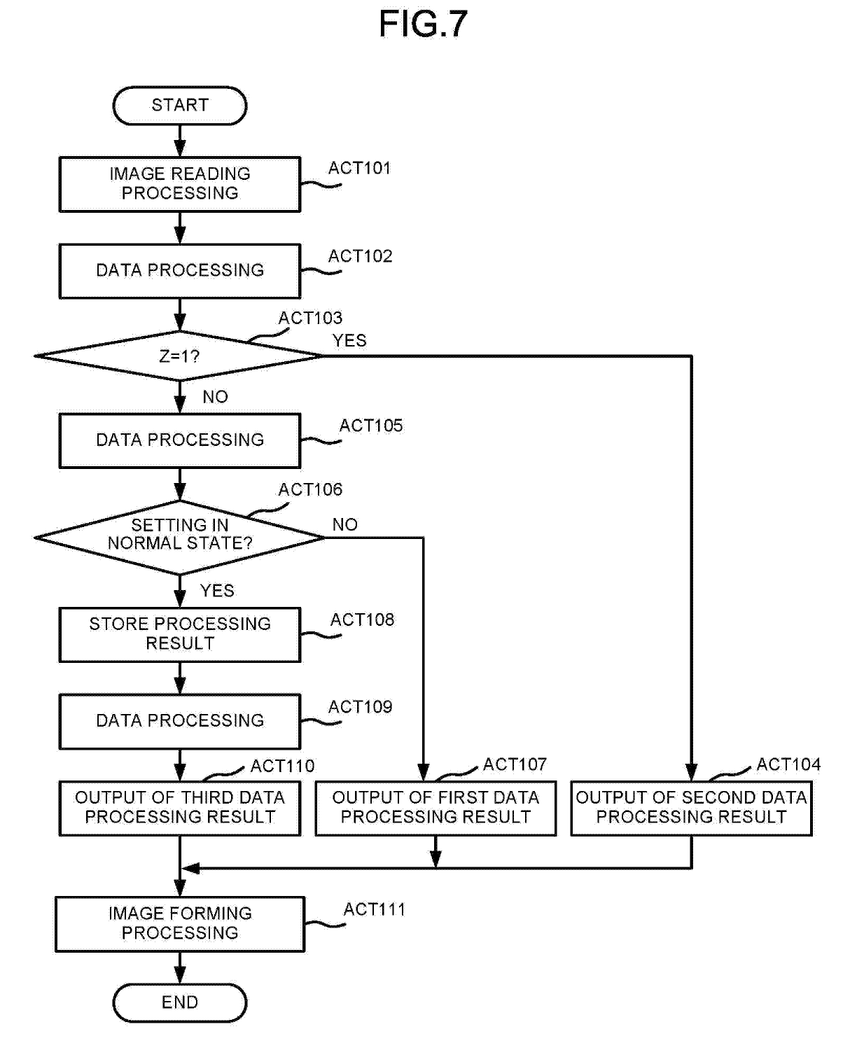

FIG. 7 is a flowchart illustrating a specific example of the flow of processing at the time of evaluating the ASIC 111 according to the embodiment. The image reading section 200 reads the image information which is the reading object (ACT 101). The second data processing section 122 executes data processing on the image information (ACT 102). The output data selection section 138 determines whether 1 (See FIG. 6) is received as the signal Z from the pin input section 115 (ACT 103). If the signal Z is 1 (Yes in ACT 103), the output data selection section 138 outputs the data processing result of the second data processing section 122. Then, the flow proceeds to the processing in ACT 111 (ACT 104).

If the signal Z is not 1 (No in ACT 103), the first data processing section 121 executes the data processing on the data processing result of the second data processing section 122 (ACT 105). The output data selection section 138 determines whether or not the setting in the normal state is made for the ASIC 111 (ACT 106). If the setting in the normal state is not made for the ASIC 111 (No in ACT 106), the output data selection section 138 outputs the data processing result of the first data processing section 121. Then, the flow proceeds to the processing in ACT 111 (ACT 107).

If the setting in the normal state is made for the ASIC 111 (Yes in ACT 106), the first CPU 107 stores the result of the data processing by the first data processing section 121 in the storage section 106 (ACT 108). The third data processing section 123 further executes the data processing on the data processing result by the first data processing section 121 (ACT 109). The output data selection section 138 outputs the data processing result of the third data processing section 123 (ACT 110). The printer section 103 executes an image forming processing based on the received data processing result (ACT 111).

In the image forming apparatus 100 constituted as described above, if the first CPU 107 which is the main CPU is not operating, the signal Z is input to the ASIC 111 by the pin input section 115. Due to the signal Z, the clock input to the output section 139 is the CLK 1 which is the same as the clock for operating the second data processing section 122. The output section 139 can output the data processed by the second data processing section 122. Therefore, even if the first CPU 107 which is the main CPU is not operating, it is possible to output the data processed by the second data processing section 122 controlled by the second CPU 109 which is a sub-CPU.

According to at least one embodiment described above, by including the pin input section 115 and the output data selection section 138, the ASIC 111 can output a large amount of data without switching the output by the first CPU 107 which is the main CPU.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a first processor configured to generate a first operation signal indicating an operation state of the first processor, and configured to generate a first output signal which outputs data generated by operation of the first processor;
a second processor configured to generate a second operation signal indicating an operation state of the second processor;
a pin input configured to generate a second output signal for outputting data generated by the second processor if the first operation signal and the second operation signal satisfy predetermined conditions; and
an application-specific integrated circuit (ASIC) configured to:
generate data and output the data based on the first output signal or the second output signal.

2. The image forming apparatus according to claim 1, wherein
the ASIC further comprises a first data processing circuit and a second data processing circuit.

3. The image forming apparatus according to claim 2, wherein
the pin input generates the second output signal if the first operation signal indicates that the first processor is not operating.

4. The image forming apparatus according to claim 3, wherein
if the second output signal is received at a logic operation circuit of the ASIC, the ASIC outputs data generated by the second processor, and
if the first output signal is received at the logical operation circuit of the ASIC, the ASIC outputs data generated by the first processor.

5. The image forming apparatus according to claim 2, wherein
if the second output signal is received at a logic operation circuit of the ASIC, the ASIC outputs data generated by the second processor, and
if the first output signal is received at the logic operation circuit of the ASIC, the ASIC outputs data generated by the first processor.

6. The image forming apparatus according to claim 2, further comprising a first phase-locked loop (PLL), wherein the first data processing circuit operates according to a clock cycle of the first PLL.

7. The image forming apparatus according to claim 6, wherein the second data processing circuit operates according to the clock cycle of the first PLL.

8. The image forming apparatus according to claim 7, further comprising a second phase-locked loop (PLL) and a third data processing circuit, the third data processing circuit formed in the ASIC, wherein the third data processing circuit operates according to a clock cycle of the second PLL.

9. The image forming apparatus according to claim 1, wherein the pin input provides a signal to a demultiplexor of the ASIC, the demultiplexor having access to a register of the ASIC.

10. A method of controlling an image forming apparatus, including:
generating a first operation signal indicating an operation state of a first processor and a first output signal for outputting data generated by the first processing section;
generating a second operation signal indicating an operation state of a second processor;
generating, by a pin input, a second output signal for outputting data generated by the second processor ; and
generating data by operation of the first processor or the second processor; and
determining whether to output the data generated by the first processor or the data generated by the second processor from an application specific integrated circuit (ASIC) based on the first output signal or the second output signal.

11. The method according to claim 10, wherein the ASIC further comprises a first data processing circuit and a second data processing circuit.

12. The method according to claim 11, wherein
the pin input generates the second output signal if the first operation signal indicates that the first processor is not operating.

13. The method according to claim 12, wherein
if the second output signal is received at a logic operation circuit of the ASIC, the ASIC outputs data generated by the second processor, and
if the first output signal is received at the logic operation circuit of the ASIC, the ASIC outputs data generated by the first processor.

14. The method according to claim 11, wherein
if the second output signal is received at a logic operation circuit of the ASIC, the ASIC outputs data generated by the second processor, and
if the first output signal is received at the logic operation circuit of the ASIC, the ASIC outputs data generated by the first processor.

15. The method according to claim 11, wherein the image forming apparatus comprises a first phase-locked loop (PLL), wherein the first data processing circuit operates according to a clock cycle of the first PLL.

16. The method according to claim 15, wherein the second data processing circuit operates according to the clock cycle of the first PLL.

17. The method according to claim 16, further comprising a second phase-locked loop (PLL) and a third data processing circuit, the third data processing circuit formed in the ASIC, wherein the third data processing circuit operates according to a clock cycle of the second PLL.

18. The method according to claim 10, wherein the pin input provides a signal to a demultiplexor of the ASIC, the demultiplexor having access to a register of the ASIC.
